(19) United States
(12) Patent Application Publication
(10) Pub. No.: US 2024/0398149 A1
(43) Pub. Date: Dec. 5, 2024

(54) ELECTRIC POT

(71) Applicant: X.J. ELECTRICS (HUBEI) CO., LTD., Huanggang (CN)

(72) Inventor: Yun PAN, Huanggang (CN)

(73) Assignee: X.J. ELECTRICS (HUBEI) CO., LTD., Huanggang (CN)

(21) Appl. No.: 18/337,630

(22) Filed: Jun. 20, 2023

(30) Foreign Application Priority Data
May 29, 2023 (CN) 202321373717.1

(51) Int. Cl. A47J 31/20

(52) U.S. Cl. CPC A47J 31/20

(57) ABSTRACT

An electric pot comprises a pot body, a pot lid rotatably connected to the pot lid, and a handle connected to the pot body. The electric pot further comprises a tea filtering net and a hanger connected to each other, a connecting block is provided at a pot spout of the pot body, a hanging groove cooperating with the hanger is provided on the connecting block, and the hanging groove is located in the pot body. When making tea, the tea filtering net loaded with tea leaves is buckled on a connecting block area inside the pot body via a hanger to be in full contact with hot water in the pot body; when filing or replacing tea, only the tea filtering net located in the pot body can be taken out without disassembling the pot lid, and there is no risk of loss of the pot lid.

### CROSS-REFERENCE TO RELATED APPLICATIONS

This application claims priority to Chinese Patent Application No. 202321373717.1, filed on May 29, 2023, the content of which is incorporated herein by reference in its entirety.

### TECHNICAL FIELD

The present application relates to the technical field of household appliances, in particular to an electric pot.

### BACKGROUND

With the improvement of people's quality of life, drinking tea and making tea has become a part of people's life, an electric pot is a common electric appliance used to burn water.

Most of the existing electric pots do not have a tea filtering net, and when a user is making tea, the hot water in the electric pots needs to be poured into other tea-making containers, and the user has some troubles in operation. For some electric pots with tea filtering nets, the tea filtering net is connected with a pot lid, when filling/changing tea, the tea filtering net needs to be taken out from the pot body together with the pot lid, and then the tea filtering net and the pot lid are separated (for example, Chinese Patent Application Publication CN110403462A), which is not easy for a user to operate. Further, after the tea filtering net and the pot lid are taken out from the pot body, the tea filtering net and the pot lid become independent individuals respectively, and the pot lid is easily lost and damaged.

### SUMMARY

The technical problem to be solved by the present application is to provide an electric pot having a tea filtering net for convenient use.

In order to solve the above technical problem, the technical solution adopted by the present application is: an electric pot comprising a pot body and a pot lid rotatably connected, a handle being connected to the pot body, wherein the tea pot further comprises a tea filtering net and a hanger connected to each other, a connecting block is provided at a pot spout of the pot body, a hanging groove cooperating with the hanger is provided on the connecting block, and the hanging groove is located in the pot body.

Further, a guide part for guiding the hanger is provided at an inlet of the hanging groove.

Further, the width of the hanging groove is gradually changed, and the width of the top of the hanging groove is greater than that of the bottom of the hanging groove.

Further, the hanger comprises an inverted L-shaped hanging part comprising a first part and a second part connected to each other, the second part is connected to the tea filtering net, and wherein the first part is flat.

Further, the connecting block is connected to the handle.

Further, a part of the area of the connecting block is located outside the pot body, and the pot lid is provided with an avoiding part for avoiding the connecting block.

Further, the connecting block includes an n-shaped buckling part that buckles an edge of the pot spout of the pot body.

Further, a buffer is further included and located between the pot body and the buckling part, and the buffer respectively contacts the pot body and the connecting block.

Further, the material of the buffer is food-grade silica gel.

Further, the connecting block is made of food grade plastic, 304 stainless steel, ceramic or glass.

The advantageous effect of the present application is that the electric pot has a tea filtering net; when making tea, the tea filtering net loaded with tea leaves is buckled on a connecting block area inside the pot body via a hanger to be in full contact with hot water in the pot body; when tea needs to be filled or replaced, only the tea filtering net located in the pot body can be taken out without disassembling the pot lid to facilitate user operation, and there is no risk of loss of the pot lid. In addition, the cooperation of the hanger and the hanging groove can make the access of the tea filtering net more labor-saving and more convenient.

### BRIEF DESCRIPTION OF THE DRAWINGS

FIG. 1 is a sectional view of an electric pot according to a first embodiment of the present application.

FIG. 2 is a sectional view of a pot body in the electric pot according to the first embodiment of the present application.

FIG. 3 is a sectional view of a tea filtering net in the electric pot according to the first embodiment of the present application.

### DETAILED DESCRIPTION OF THE EMBODIMENTS

In order to explain the technical contents, the objects, and the effects of the present application in detail, the embodiments will be described below with reference to the accompanying drawings.

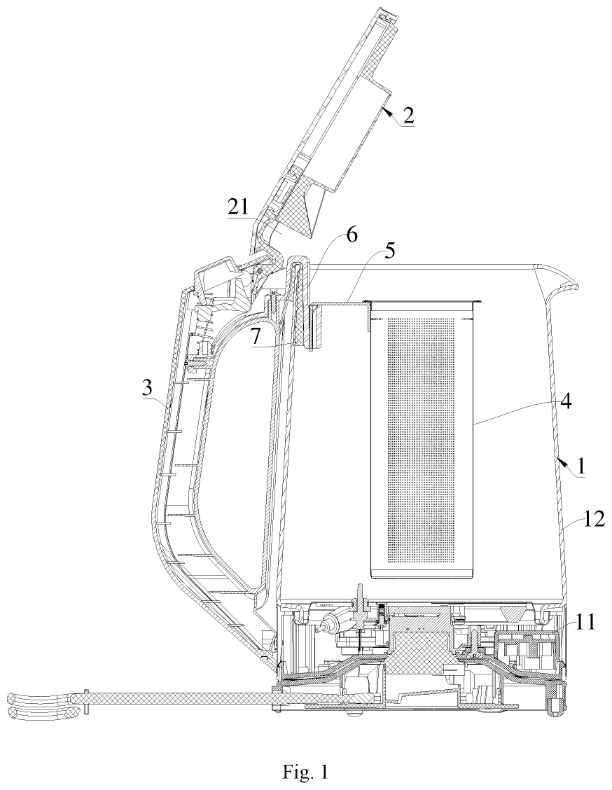

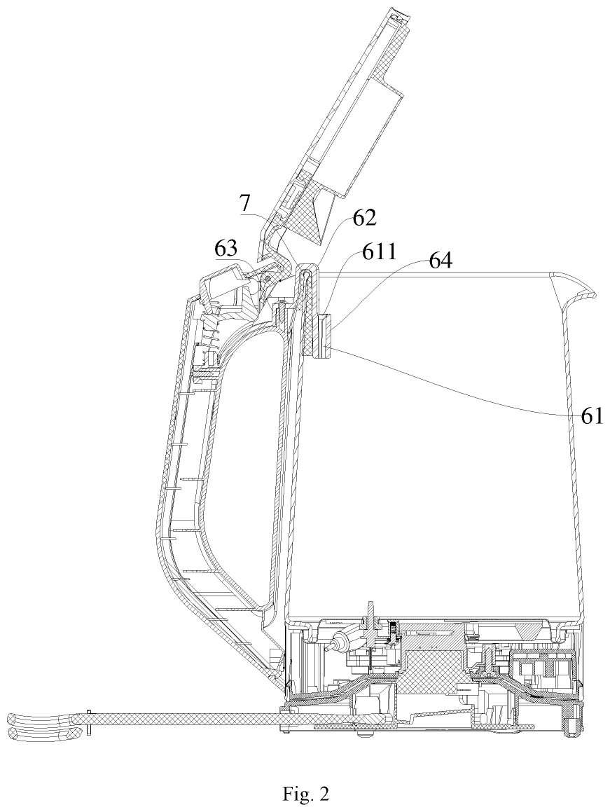

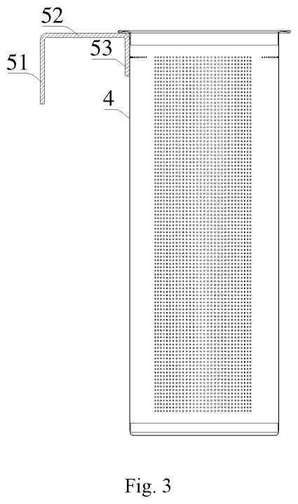

With reference to FIGS. 1 to 3, an electric pot comprises a pot body 1 and a pot lid 2 rotatably connected, wherein the pot body 1 is connected to a handle 3, and further comprises a tea filtering net 4 and a hanger 5 connected to each other, a connecting block 6 is provided at a pot spout of the pot body 1, a hanging groove 61 cooperating with the hanger 5 is provided on the connecting block 6, and the hanging groove 61 is located in the pot body 1.

As apparent from the above description, the present application has an advantageous effect in that: the electric pot has a tea filtering net 4, when making tea, the tea filtering net 4 loaded with tea leaves is buckled on a connecting block 6 area inside the pot body 1 via a hanger 5 to be in full contact with the hot water in the pot body 1; and when tea needs to be filled or replaced, only the tea filtering net 4 located in the pot body 1 can be taken out without disassembling the pot lid 2 to facilitate user operation, and there is no risk of loss of the pot lid 2. In addition, the cooperation of the hanger 5 and the hanging groove 61 can make the access of the tea filtering net 4 less labor and more convenient.

Further, a guide part 611 for guiding the hanger 5 is provided at an inlet of the hanging groove 61.

As can be seen from the above description, the provision of the guide part 611 makes it easier for the user to catch the hanger 5 on the connecting block 6.

Further, the width of the hanging groove 61 is gradually changed, and the width of the top of the hanging groove 61 is greater than that of the bottom of the hanging groove 61.

It can be seen from the above-mentioned description that in the process of hanging the tea filtering net 4, as the degree of sinking of the tea filtering net 4 in the pot body 1 becomes greater, the degree of close fit between the hanging groove 61 and the hanger 5 becomes greater, so that the hanger 5 is sufficiently limited, avoiding the hanger 5 hitting the connection block 6 to generate abnormal sound when the electric pot is used to cook tea, which is beneficial to improving the user's use experience.

Further, the hanger 5 comprises an inverted L-shaped hanging part 64, wherein the hanging part 64 comprises a first part 51 and a second part 52 connected to each other, wherein the second part 52 is connected to the tea filtering net 4, and wherein the first part 51 is flat.

It can be seen from the above-mentioned description that the hanger 5 has a simple structure, is easy to manufacture and is cheap to produce. The flattened first part 51 facilitates gripping by a user.

Further, the connecting block 6 is connected to the handle 3.

It can be seen from the above-mentioned description that the connecting block 6 is connected to the handle 3 to facilitate the assembly work of the electric pot, and at the same time, improve the structural stability of the electric pot.

Further, part of the area of the connecting block 6 is located outside the pot body 1, and the pot lid 2 is provided with an avoiding part 21 for avoiding the connecting block 6.

It can be seen from the above-mentioned description that the arrangement of the avoiding part 21 can prevent the pot lid 2 from interfering with the connecting block 6, so that the pot lid 2 cannot cover the pot spout of the pot body 1.

Further, the connecting block 6 comprises an n-shaped buckling part 62 that buckles an edge of the pot spout of the pot body 1.

It can be seen from the above description that the presence of the buckling part 62 can further improve the structural stability of the electric pot.

Further, a buffer 7 is further included and located between the pot body 1 and the buckling part 62, and the buffer 7 respectively contacts the pot body 1 and the connecting block 6.

As can be seen from the above description, the buffer 7 prevents the buckling part 62 from crushing the pot body 1.

Further, the buffer 7 is made of food-grade silica gel.

Further, the connecting block 6 is made of food grade plastic, 304 stainless steel, ceramic or glass.

As can be seen from the above description, the electric pot is safe to use.

### Embodiment 1

With reference to FIGS. 1 to 3, an embodiment of the present application is: an electric pot comprises a pot body 1 and a pot lid 2 rotatably connected, wherein the pot body 1 is connected to a handle 3, and further comprises a tea filtering net 4 and a hanger 5 connected to each other, a connecting block 6 is provided at a pot spout of the pot body 1, a hanging groove 61 cooperating with the hanger 5 is provided on the connecting block 6, and the hanging groove 61 is located in the pot body 1, and when making tea, the tea filtering net 4 hangs in the pot body 1 through the cooperation of the hanger 5 and the hanging groove 61. Alternatively, the tea filtering net 4 is welded, screwed or otherwise attached to the hanger 5.

A guide part 611 for guiding the hanger 5 is provided at the inlet of the hanging groove 61, and in this embodiment, the cross section of the guide part 611 is an inverted trapezoid.

Preferably, the width of the hanging groove 61 is gradually changed, and the width of the top of the hanging groove 61 is greater than the width of the bottom of the hanging groove 61. This makes it easier for the hanger 5 to hang into the hanging groove 61, thereby facilitating the user's access to the tea filtering net 4.

Specifically, the hanger 5 comprises an inverted L-shaped hanging part 64, wherein the hanging part 64 comprises a first part 51 and a second part 52 connected to each other, the second part 52 is connected to the tea filtering net 4, and the first part 51 is flat. In this embodiment, the hanging part 64 further comprises a third part 53, an end of the second part 52 away from the first part 51 is connected to the third part 53 which is parallel to the first part 51, and the third part 53 is welded or screwed to an outer wall of the tea filtering net 4; in other embodiments, the third part 53 may also be annular, with the edge of the tea filtering net 4 hanging on the third part 53 through its spout. Of course, in some embodiments, the hanger 5 may have other configurations.

Alternatively, the connecting block 6 is connected to the handle 3, specifically, part of the area of the connecting block 6 is located outside the pot body 1, and the pot lid 2 is provided with an avoiding part 21 for avoiding the connecting block 6. More specifically, the connecting block 6 comprises an n-shaped buckling part 62 for buckling the edge of the spout of the pot body 1.

In this embodiment, the connecting block 6 further comprises a mounting part 63 and a hanging part 64 respectively connecting the buckling part 62, the handle 3 is provided with a mounting groove, the mounting part 63 is located in the mounting groove, alternatively, the mounting part 63 is fastened to the handle 3 by a fastener, and the hanging groove 61 is provided on the hanging part 64. Such fasteners include, but are not limited to, screws, snaps, and the like.

The pot body 1 comprises a base 11 and a container 12 connected to each other, wherein the base 11 is mounted below the container 12, the bottom of the handle 3 is connected to the base 11, the top of the handle 3 is connected to the pot lid 2, and the buckling part 62 buckles on the edge of the pot spout of the container 12. Thus, both the upper part and the lower part of the container 12 can be sufficiently and effectively fixed, which is advantageous for improving the structural stability of the electric pot.

In order to prevent the buckling part 62 from crushing the pot body 1, and in particular, in order to prevent the buckling part 62 from crushing the container 12, the electric pot further comprises a buffer 7, wherein the buffer 7 is located between the pot body 1 and the buckling part 62, the buffer 7 respectively contacts the pot body 1 and the connecting block 6, and the buffer 7 is n-shaped.

In order to improve the safety of the electric pot, the material of the buffer 7 is preferably food-grade silica gel. The material of the connecting block 6 is food-grade plastic, 304 stainless steel, ceramic or glass, and the material of the container 12 is food-grade plastic, 304 stainless steel, ceramic or glass.

In summary, the present application provides an electric pot having a tea filtering net, when making tea, the tea filtering net loaded with tea leaves is buckled on a connecting block area inside the pot body via a hanger to be in full contact with hot water in the pot body; when tea needs to be filled or replaced, only the tea filtering net located in the pot body can be taken out without disassembling the pot lid to facilitate user operation, and there is no risk of loss of the pot lid. In addition, the cooperation of the hanger and the hanging groove can make the access of the tea filtering net more labor-saving and more convenient.

While the foregoing is directed to embodiments of the present application, other and further embodiments of the application may be devised without departing from the basic scope thereof, and the scope thereof is determined by the claims that follow.

What is claimed is:

1. An electric pot, comprising a pot body, a pot lid rotatably connected to the pot body, and a handle connected to the pot body, wherein
the electric pot further comprises a tea filtering net and a hanger connected to each other, a connecting block is provided at a pot spout of the pot body, a hanging groove cooperating with the hanger is provided on the connecting block, and the hanging groove is located in the pot body.

2. The electric pot according to claim 1, wherein a guide part for guiding the hanger is provided at an inlet of the hanging groove.

3. The electric pot according to claim 1, wherein a width of the hanging groove is gradually changed, and a width of a top of the hanging groove is greater than a width of a bottom of the hanging groove.

4. The electric pot according to claim 1, wherein the hanger comprises an inverted L-shaped hanging part comprising a first part and a second part connected to each other, the second part is connected to the tea filtering net, and the first part is flat.

5. The electric pot according to claim 1, wherein the connecting block is connected to the handle.

6. The electric pot according to claim 5, wherein a part of an area of the connecting block is located outside the pot body, and the pot lid is provided with an avoiding part for avoiding the connecting block.

7. The electric pot according to claim 6, wherein the connecting block includes an n-shaped buckling part that buckles an edge of the pot spout of the pot body.

8. The electric pot according to claim 7, further comprising a buffer located between the pot body and the buckling part, and the buffer respectively contacting the pot body and the connecting block.

9. The electric pot according to claim 8, wherein the buffer is made of food-grade silica gel.

10. The electric pot according to claim 1, wherein the connecting block is made of one of food grade plastic, 304 stainless steel, ceramic and glass.
